(19) United States
(12) Patent Application Publication
(10) Pub. No.: US 2011/0063582 A1
(43) Pub. Date: Mar. 17, 2011

(54) COOLING PUMP UNIT AND PROJECTION DISPLAY APPARATUS INCLUDING THE SAME

(76) Inventor: Junsi Lee, Tokyo (JP)

(21) Appl. No.: 12/736,832

(22) PCT Filed: May 16, 2008
(86) PCT No.: PCT/JP2008/059047

§ 371 Date: Nov. 15, 2010

(51) Int. Cl. F04B 43/08; G03B 21/16

(52) U.S. Cl. 353/52; 417/474

(57) ABSTRACT

Generation of noise is suppressed by solving the problems of crushing and wear of a cushion caused by thermal expansion of a communicating tube. A pump unit includes main pump body 1 for discharging compressed air, a communicating tube made of an elastomer and having its one end fitted to a discharge opening of the main pump body 1, pump fixing portion 2 for holding a part of a portion of the communicating tube other than its portion fitted to the discharge opening, cushions 13a and 13b arranged on an outer circumferential surface of main pump body 1, and films 15a and 15b arranged on surfaces of cushions 13a and 13b. Films 15a and 15b have smooth surfaces, and friction coefficients of the smooth surfaces are smaller than those of cushions 13a and 13b.

### TECHNICAL FIELD

The present invention relates to a cooling pump unit of a projection display apparatus represented by a liquid crystal projector.

### BACKGROUND ART

For a cooling apparatus of the projection display apparatus, a cooling pump such as a diaphragm pump is used. Generally, the pump has a usable life period. Thus, a cooling apparatus (cooling pump unit) of an exchangeable unit structure is used.

The cooling pump vibrates during its operation. The vibration of the cooling pump is transmitted to the casing of the projection display apparatus to generate noise.

Japanese Utility Model Application Laid-Open No. 05-13402 describes a pump fixing structure where measures have been taken against pump vibration. The pump fixing structure includes a pressure pump, a cushion material to cover the outer circumferential surface of the pressure pump, a receiving body having a surface on which a half surface of the outer circumference of the pressure pump covered with the cushion material abuts, and a cover body which is joined to the receiving body and by which the pressure pump is pressed against the surface of the receiving body. Absorbing vibration of the pressure pump suppresses generation of noise.

The vibration of the pump is transmitted to the casing not only from the outer circumferential surface of the pump but also through a communicating tube attached to the discharge opening of the pump. In the pump fixing structure, while the vibration transmitted to the casing from the outer circumferential surface of the pump is absorbed, the vibration transmitted to the casing through the communicating tube cannot be absorbed. Consequently, the vibration transmitted to the casing through the communicating tube generates noise.

Thus, a pump unit has been presented, which can absorb not only the vibration transmitted to the casing from the outer circumferential surface of the pump but also the vibration transmitted to the casing through the communicating tube (see JP2008-96459A).

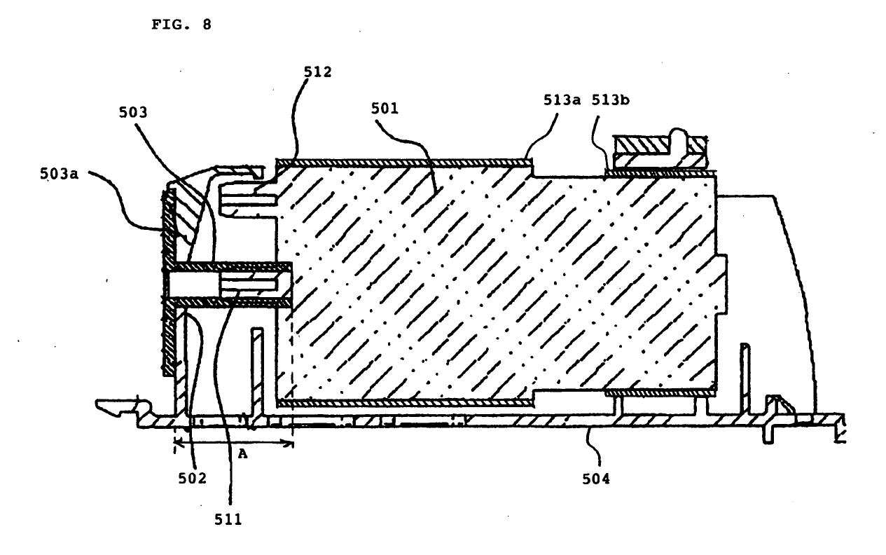

FIG. 8 is a sectional view showing the pump unit described in JP2008-96459A. This pump unit includes main pump body 501 that includes discharge opening 511 and suction opening 512, communicating tube 503 which is made of an elastomer and one end of which is fitted to discharge opening 511, and pump fixing portion 502 for fixing a part of communicating tube 503. Main pump body 501 is fixed to cover 504 only by pump fixing portion 502.

Disk-shaped gasket portion 503a is disposed in the other end of communicating tube 503. When cover 504 is attached to the casing, the other end of communicating tube 503 is pressed against an area of the casing side that includes a ventilating hole. Communicating tube 350 accordingly communicates with the ventilating hole. In this state, gasket portion 503a serves to prevent leakage of compressed air supplied through communicating tube 503.

Cushions 513a and 513b, which serves as buffer members, are arranged in portions of the outer circumferential surface of main pump body 501 that come into contact with other members.

The vibration of main pump body 501 is transmitted to the casing through the portion for fixing main pump body 501 and a portion contacted by main pump body 501. According to the configuration shown in FIG. 8, a part of communicating tube 503 attached to discharge opening 511 is fixed by pump fixing portion 502, while main pump body 501 itself is not fixed to cover 4. Thus, when main pump body 501 is not in contact with any other members, the vibration of main pump body 501 is transmitted to the casing only through communicating tube 503 attached to discharge opening 511. Communicating tube 503 is made of the elastomer, and hence most of the vibration transmitted through communicating tube 503 to the casing is absorbed by communicating tube 503.

In the state where the circumferential surface of main pump body 501 is in contact with cover 4 or the casing, vibrations of main pump body 501 are transmitted through the contact area to the casing, thereby generating noise. According to the configuration shown in FIG. 8, cushions 513a and 513b are arranged in the areas of the outer circumferential surface of main pump body 501 that come into contact with cover 4 and the casing. Most of the vibration transmitted from the outer circumferential surface of main pump body 501 to the casing side is accordingly absorbed by cushions 513a and 513b.

### DISCLOSURE OF THE INVENTION

However, the pump unit described in JP2008-96459A has the following problems.

Generally, a motor is used as the power source of a pump. The motor generates heat, which increases the temperature of the air flow fed by pressure from the pump. In the diaphragm pump, the bearing of the diaphragm generates heat by friction, which increases the temperature of the air flow fed by pressure from the pump. When the temperature of the air flow fed by pressure from the pump increases, communicating tube 503 is heated by the air flow, and the temperature of communicating tube 503 increases. Communicating tube 503 is made of an elastomer such as rubber, and hence the temperature increase is accompanied by an increase in communicating tube length A shown in FIG. 8. As a result, force is applied on main pump body 501 to press main pump body 501 in a direction (first direction) opposed to communicating tube 503 side.

Cushions 513a and 513b are made of foam materials excellent in buffer performance and sound insulation. Friction coefficients of the surfaces thereof are accordingly high. Thus, in the contacted state of cushions 513a and 513b with cover 504 or the casing, when the force of the first direction is applied on main pump body 501, frictional forces on the contacted portions may be greater than the force of the first direction. In this case, the force of the first direction is received by cushions 513a and 513b that are in contact with the outer circumferential surface of main pump body 501, which results in the crushing of cushions 513a and 513b by main pump body 501. When cushions 513a and 513b are crushed, a crushing margin for absorbing the vibration of the pump is reduced by a corresponding amount. This results in a problem in which noise is generated because of insufficient absorption of the vibration of the pump by cushions 513a and 513b.

When the frictional forces are smaller than the force of the first direction, main pump body 501 moves in the first direction. The movement of main pump body 501 causes wear of cushions 513a and 513b on the contacted portions. When the pump stops, the temperature of communicating tube 503 drops due to natural cooling, which is accompanied by a reduction in communicating tube length A. In this case, force is applied in a second direction reverse to the first direction to move main pump body 501 in the second direction. This movement of main pump body 501 also causes wear of cushions 513a and 513b on the contacted portions. Thus, when the pump is driven or stopped, main pump body 501 moves in the first or second direction, causing wear of cushions 513a and 513b. With further wear of cushions 513a and 513b, the buffer performance of the cushions is reduced. This results in a problem in which noise is generated because of insufficient absorption of the vibration of the pump by cushions 513a and 513b.

Vibration during transport causes movement of main pump body 501, which results in the wear of cushions 513a and 513b. This wear increases noise.

It is an object of the present invention to provide a pump unit capable of solving the abovementioned problems and suppressing generation of noise caused by crushing or wear of cushions, and a projection display apparatus.

In order to achieve the object, a pump unit according to the present invention includes a cooling pump for discharging compressed air, and a cover for housing the cooling pump. The pump unit includes:

a communicating tube made of an elastomer, and having one end fitted to a discharge opening of the cooling pump, and a portion other than the fitting portion set as a fixing portion with the cover;

buffer members arranged on an outer circumferential surface of the cooling pump; and

lubricating members arranged on surfaces of the buffer members.

In this case, the lubricating members include smooth surfaces, and friction coefficients of the smooth surfaces are smaller than those of the buffer members.

Another pump unit according to the present invention includes a cooling pump for discharging compressed air, and a cover for housing the cooling pump. The pump unit includes:

a communicating tube made of an elastomer, and having one end fitted to a discharge opening of the cooling pump, and a portion other than the fitting portion set as a fixing portion with the cover;

lubricating members arranged on an inner surface of the cover; and

lubricating members arranged on surfaces of the buffer members.

In this case, the lubricating members include smooth surfaces, and friction coefficients of the smooth surfaces are smaller than those of the buffer members.

A projection display apparatus according to the present invention includes a light source, and an optical system that projects image light obtained by spatially modulating light from the light source. The projection display apparatus includes:

a casing for housing the light source and the optical system; and

a pump unit attached to the casing.

In this case, the pump unit includes:

a cooling pump for discharging compressed air;

a communicating tube made of an elastomer, and having one end fitted to a discharge opening of the cooling pump, and a portion other than the fitting portion set as a fixing portion with the cover;

buffer members arranged on an outer circumferential surface of the cooling pump; and

lubricating members arranged on surfaces of the buffer. members.

The lubricating members include smooth surfaces, and friction coefficients of the smooth surfaces are smaller than those of the buffer members.

At least the light source is cooled by the compressed air introduced into the casing through the communicating tube.

Another projection display apparatus according to the present invention includes a light source, and an optical system that projects image light obtained by spatially modulating light from the light source. The projection display apparatus includes:

a casing for housing the light source and the optical system; and

a pump unit attached to the casing.

In this case, the pump unit includes:

a cooling pump for discharging compressed air;

a communicating tube made of an elastomer, and having one end fitted to a discharge opening of the cooling pump, and a portion other than the fitting portion set as a fixing portion with the cover;

lubricating members arranged on an inner surface of the cover; and

lubricating members arranged on surfaces of the buffer members.

The lubricating members include smooth surfaces, and friction coefficients of the smooth surfaces are smaller than those of the buffer members.

A least the light source is cooled by the compressed air introduced into the casing through the communicating tube.

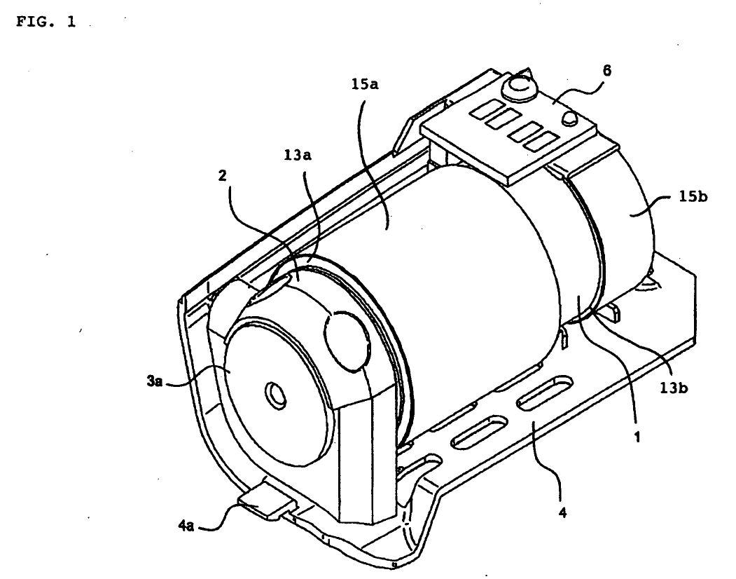

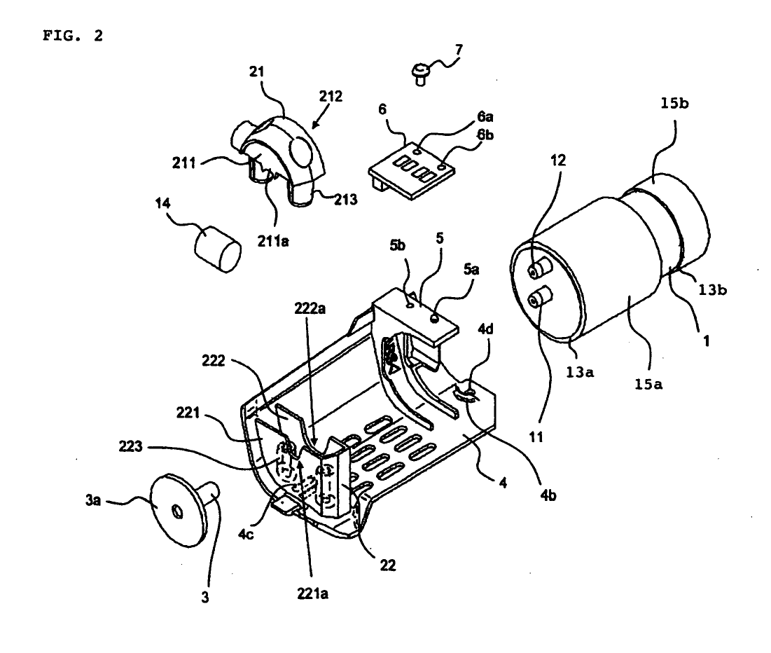

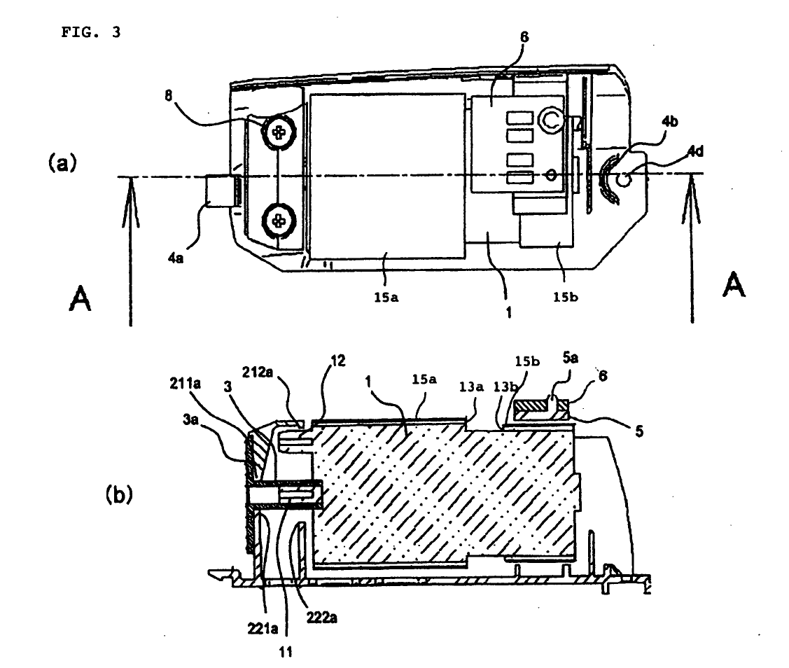

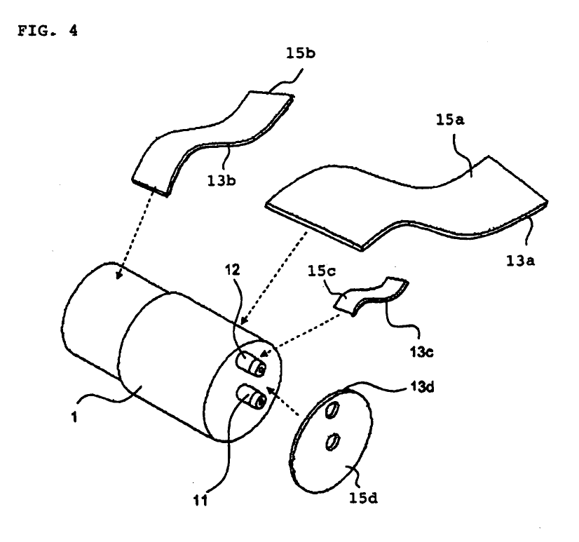

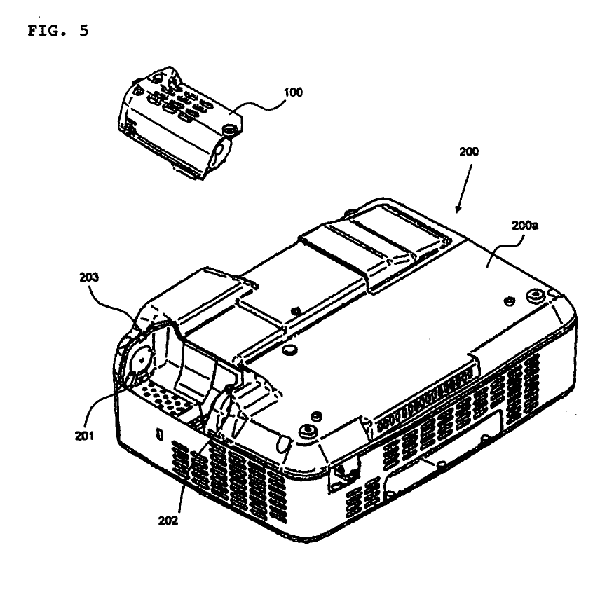

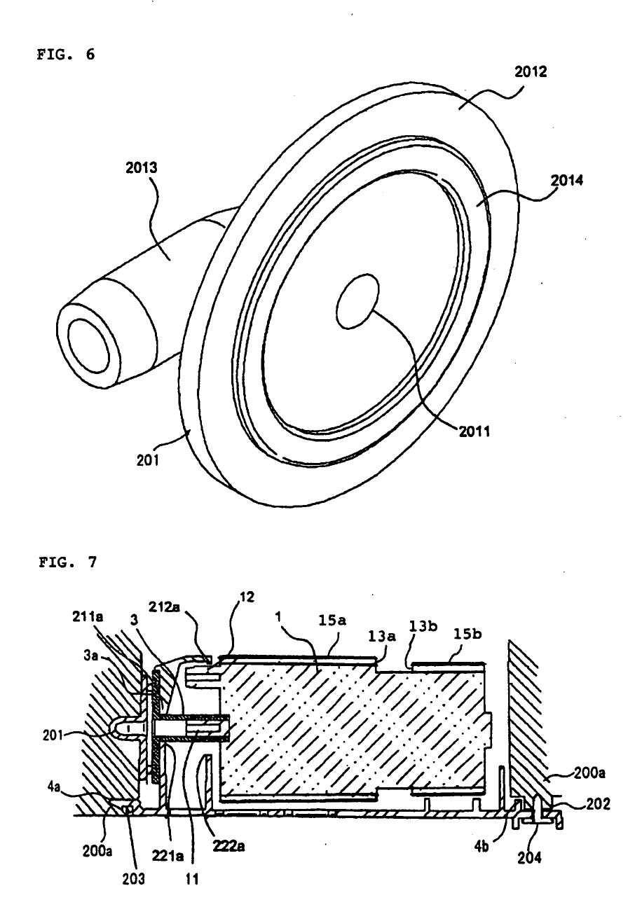

### BRIEF DESCRIPTION OF THE DRAWINGS

[FIG. 1]A perspective view showing a pump unit according to an embodiment of the present invention.

[FIG. 2] An exploded perspective view of the pump unit shown in FIG. 1.

[FIGS. 3A and 3B] Explanatory diagrams of a state where a main pump body shown in FIG. 1 is fixed by a pump fixing portion: FIG. 3A is a top view, and FIG. 3B is a sectional view taken along the line A-A shown in FIG. 3A.

[FIG. 4] A schematic view showing an example of a cushion structure provided in the main pump body shown in FIG. 1.

[FIG. 5] A perspective view showing a configuration of a projector on which the pump unit shown in FIG. 1 is mounted.

[FIG. 6] A perspective view showing a configuration of a member for forming a main-body cooling ventilating hole shown in FIG. 5.

[FIG. 7] A sectional view showing a loaded state of the pump unit shown in FIG. 1 on a casing.

[FIG. 8] A sectional view of a pump unit described in JP2008-96459A.

### EXPLANATIONS OF REFERENCE NUMERALS

1 Main pump body
2 Pump fixing portion
3 Communicating tube
3a Gasket portion
4 Cover
4a Projection
6 Electric contact
13a, 13b Cushion
15a, 15b Film

### BEST MODE FOR CARRYING OUT THE INVENTION

Hereinafter, referring to the drawings, an embodiment of the present invention is described.

FIG. 1 is a perspective view showing a configuration of a pump unit according to the embodiment of the present invention, and FIG. 2 is an exploded perspective view of the pump unit shown in FIG. 1.

Referring to FIG. 1 and FIG. 2, the pump unit is a detachable unit attached to a casing of an electronic device that includes a heat source such as a light source. A main portion thereof includes main pump body 1, pump fixing portion 2, communicating tube 3, and cover 4. Main pump body 1 is a pressure pump such as a diaphragm pump.

A portion of main pump body 1 likely to come into contact with other members is covered with a cushion member serving as a buffer member. The cushion member is made of an elastomer such as spongy rubber or a synthetic resin (foam material) capable of absorbing vibration or shocks. In FIG. 1, an outer circumferential surface of main pump body 1 is covered with cushions 13a and 13b.

Films 15a and 15b serving as lubricating members are formed on surfaces of cushions 13a and 13b. Surfaces of films 15a and 15b are smooth, and friction coefficients thereof are smaller than those of the surfaces of cushions 13a and 13b. Films 15a and 15b and cushions 13a and 13b are fixed together by, for example, adhesives. For films 15a and 15b, polyethylene terephthalate (PET) sheets, polycarbonate (PC) sheets, or kapton sheets can be used. When cushions are formed on curved surfaces, the thicknesses of films 15a and 15b are advisably set to 0.05 millimeters to 0.5 millimeters. According to the embodiment, for films 15a and 15b, PET sheets having thicknesses of 0.15 millimeters are used.

Main pump body 1 gets air from suction opening 12, compresses the air, and discharges the compressed air from discharge opening 11. Cylindrical filter 14 is attached to suction opening 12 to prevent incursion of dust into the pump.

Communicating tube 3 is made of an elastomer such as rubber or a synthetic resin, and has its one end fitted to discharge opening 11. Disk-shaped gasket portion 3a is disposed in the other end of communicating tube 3. In a state where the other end of communicating tube 3 is pressed against an area of a casing side that has a ventilating hole that enables communication between communicating tube 3 and the ventilating hole, gasket portion 3a serves to prevent leakage of the compressed air supplied through communicating tube 3.

Cover 4 includes projection 4a inserted into a hole formed in a predetermined place of a unit attaching portion of the casing, receiving portion 4b engaged with the projection located in the predetermined place of the unit attaching portion, a plurality of outside aid inlets 4c, and hole 4d for screwing cover 4 to the casing. Engaging the projection of the casing side with receiving portion 4b in the inserted state of projection 4a into the hole of the casing side enables accurate attaching positioning of the pump unit to the casing. In the positioned state, hole 4d is located directly above a screw hole formed in a predetermined place of the casing. Through hole 4d, a screw is inserted into the screw hole of the casing side to fix cover 4 to the casing.

Cover 4 includes, in its inner wall, pump fixing portion 2 for fixing main pump body 1, and electric contact support portion 5. Electric contact support portion 5 is for attaching electric contact 6. Projection 5a and hole 5b for inserting rivet 7 are formed in an attaching surface of electric contact 6. Electric contact 6 includes the construction in which a plurality of contacts is arranged on a substrate to interconnect pump man body 1 and a pump driving portion (not shown). On the substrate, hole 6a into which projection 5a is fitted, and hole 6b into which rivet 7 is inserted are formed. In the fitted state of hole 6a of electric contact 6 around projection 5a of electric contact support portion 5, rivet 7 is inserted into holes 6b and 5b to fix electric contact 6 to electric contact support portion 5.

Pump fixing portion 2 includes pressing member 21 and receiving member 22. Receiving member 22 is formed into a U shape in section, and includes wall portion 221 of a front side (side where the ventilating hole of the casing is located during unit loading), wall portion 222 of a rear side (side where main pump body 1 is located), and columnar screwing portion 223 disposed between these wall portions to screw pressing member 21. Front receiving portion 221a and rear receiving portion 222a are respectively formed on upper ends of wall portions 221 and 222. Front receiving portion 221a and rear receiving portion 222a are formed by notching parts of the wall portions in concave shapes.

Pressing member 21 includes wall portion 211 of a front side having its lower end abutted on the upper end of wall portion 221 and wall portion 212 of a rear side having its lower end abutted on the upper end of wall portion 222. Columnar guide portion 213 is disposed between wall portions 211 and 212 to guide insertion of the screw into screwing portion 223. Front receiving portion 211a and rear receiving portion (not shown) are respectively formed in the lower ends of wall portions 211 and 212. Front receiving portion 211a and rear receiving portion are formed by notching parts of the wall portions in concave shapes.

In the screwed state of pressing member 21 to receiving member 22, wall portion 211 of pressing member 21 and wall portion 221 of receiving member 22 constitute a uniform surface. On a part of the surface, front receiving portion 211a of wall portion 211 and front receiving portion 221a of wall portion 221 constitute an opening. Since the diameter of the opening is smaller than the outer diameter of communicating tube 3, a part of communicating tube 3 can be fixed by the opening. Similarly, in the screwed state, wall portion 212 of pressing member 21 and wall portion 222 of receiving member 22 constitute a uniform surface. On a part of the surface, the rear receiving portion of wall portion 212 and rear receiving portion 222a of wall portion 222 constitute an opening. The space generated by this opening is large enough to insert discharge opening 11 and suction opening 12 of main pump body 1. Discharge opening 11 and suction opening 12 of main pump body 1 do not come into contact with the rear receiving portion of wall portion 212 and rear receiving portion 222a of wall portion 222.

FIGS. 3A and 3B are explanatory diagrams of a state where main pump body 1 is fixed by pump fixing portion 2: FIG. 3A is a top view, and FIG. 3B is a sectional view taken along the line A-A shown in FIG. 3A.

As shown in FIG. 3A, pressing member 21 is screwed to receiving member 22 by screws 8. As shown in FIG. 3B, one end of communicating tube 3 is fitted to discharge opening 11 of main pump body 1. A part of a portion (portion that includes gasket portion 3a) of communicating tube 3, excluding the portion fitted to discharge opening 11, is fixed by front receiving portion 211a of wall portion 211 and front receiving portion 221a of wall portion 221. Gasket portion 3a is disposed on the uniform surface constituted by wall portions 211 and 221. During unit loading, gasket portion 3a prevents leakage of compressed air supplied through communicating tube 3. Discharge opening 11 and suction opening 12 of pump man body 1 are arranged in the opening constituted by rear receiving portion 212a of wall portion 212 and rear receiving portion 222a of wall portion 222.

Vibrations from main pump body 1 are transmitted to the casing through a portion of fixing main pump body 1 and a portion contacted by main pump body 1. According to the fixed state shown in FIGS. 3A and 3B, a part of communicating tube 3 attached to discharge opening 11 is fixed by pump fixing portion 2. This means that main pump body 1 is not actively fixed. In other words, no unit is provided to fix main pump body 1 itself to cover 4. Thus, unless main pump body 1 is in contact with the other members, the vibrations from main pump body 1 are transmitted to the casing only through communicating tube 3 attached to discharge opening 11. However, since communicating tube 3 is made of the elastomer, most of the vibrations transmitted from main pump body 1 to communicating tube 3 are absorbed by communicating tube 3. This prevents problems such as generation of noise due to transmission of vibrations from main pump body 1 through pump fixing portion 2 to the casing.

The pump is fixed only by communicating tube 3, and hence main pump body 1 may come into contact with cover 4 or the casing. Cushions 13a and 13b area arranged on portions of the outer circumferential surface of main pump body 1 likely to come into contact with cover 4 or the casing. Most of the vibrations transmitted from the outer circumferential surface of main pump body 1 to cover 4 or the casing are accordingly absorbed by cushions 13a and 13b.

When a power source (motor) of main pump body 1 or the bearing of the diaphragm generates heat, and the heat raises the temperature of the air flow fed by pressure from discharge opening 11, the temperature of communicating tube 3 increases. The temperature increase is accompanied by an increase in the length of communicating tube 3 due to thermal expansion. Consequently, a force is applied on main pump body 1 to press main pump body 1 in a direction (first direction) opposed to communicating tube 3 side. Films 15a and 15b serving as lubricating members are formed on the surfaces of cushions 13a and 13b. Sufficiently reducing friction coefficients of the smooth surfaces of films 15a and 15b enables setting of frictional forces on contact surfaces between the smooth surfaces and the other members (the cover and the casing) smaller than that (force of a first direction) applied on the cooling pump by thermal expansion of communicating tube 3. When the frictional forces on the contact surfaces are smaller than that of the first direction generated by the thermal expansion of communicating tube 3, cooling pump 1 moves in the first direction. Crushing of films 15a and 15b by the force of the first direction can accordingly be suppressed. Thus, the vibration of the pump can be sufficiently absorbed by films 15a and 15b to reduce noise.

The surfaces of cushions 13a and 13b are protected by films 15a and 15b serving as the lubricating members. This prevents wear of cushions 13a and 13b when main pump body 1 moves following driving or stopping of the pump, or when main pump body 1 moves due to vibration during transport. Thus, buffer performance and sound insulation of cushions 13a and 13b can be maintained for a long period of time.

The places where the cushions are installed are not limited to the outer circumferential surface of main pump body 1. In addition to the outer circumferential surface of main pump body 1, the cushions can be arranged in other contact areas that come into contact with main pump body 1. For example, a rear portion of main pump body 1 (the portion opposed to the side that includes discharge opening 11) comes into contact with electric contact support portion 5, or suction opening 12 comes into contact with rear receiving portion 212a of wall portion 212. The surface of main pump body 1 that includes discharge opening 11 and suction opening 12 comes into contact with the surface constituted by wall portion 212 of pressing member 21 and wall portion 222 of receiving member 22. In such a case, a cushion is advisably installed in each contact area. Also advisably, a lubricating member such as a film is installed in a surface of the cushion disposed in each contact area to suppress wear of the cushion.

FIG. 4 shows an example of a cushion structure provided in main pump body 1. Referring to FIG. 4, the outer circumferential surface of main pump body 1 is covered with cushions 13a and 13b, suction opening 12 is covered with cushion 13c, and the surface of main pump body 1 that includes discharge opening 11 and suction opening 12 is covered with cushion 13d. Cushion 13d is almost equal in size to the surface that includes discharge opening 11 and suction opening 12, and includes holes to insert discharge opening 11 and suction opening 12. Films 15a and 15b serving as lubricating members are arranged on surfaces of cushions 13a to 13d.

According to the cushion structure shown in FIG. 4, when the outer circumferential surface of main pump body 1 comes into contact with the inner wall of cover 4 (including electric contact support portion 5) or the members of the casing side, vibrations from main pump body 1 or shocks to pump man body 1 are absorbed by cushions 13a and 13b. When suction opening 12 comes into contact with rear receiving portion 212a of wall portion 212, vibrations from main pump body 1 or shocks to main pump body 1 are absorbed by cushion 13c. When the surface that includes discharge opening 11 and suction opening 12 comes into contact with the surface constituted by wall portion 212 of pressing member 21 and wall portion 222 of receiving member 22, vibrations from main pump body 1 or shocks to main pump body 1 are absorbed by cushion 13d.

The surfaces of cushions 13a to 13d are protected by films 15a to 15d serving as the lubricating members. This prevents wear of cushions 13a to 13d when main pump body 1 moves following driving or stopping of the pump or when main pump body 1 moves due to vibrations during transport. Thus, buffer performance and sound insulation of cushions 13a to 13d can be maintained for a long period of time.

In the configuration shown in FIGS. 1 to 4, cushions 13a and 13b are arranged to cover the entire outer circumferential surface of main pump body 1 in a circumferential direction. However, the arrangement is not limited to this. Cushions 13a and 13b can be formed only in places of the outer circumferential surface that come into contact with the other members. Limiting a forming range of cushions enables cost reduction. Advisably, however, a range of contact areas (range where cushions are arranged) is determined based on a moving range of main pump body 1 due to thermal expansion of communicating tube 3 or vibration during the transport.

When the cushions are partially provided, cushion sticking positions must be accurately obtained. On the other hand, when the cushions are arranged over the entire circumference, cushion sticking positions do not need to be obtained accurately, and hence the cushions can be easily struck to main pump body 1. Cushions 13c and 13d can also be formed only in places that come into contact with the other members.

Films 15a and 15b are formed on the entire surfaces of cushions 13a to 13d. However, the arrangement is no limited to this. Films 15a and 15b can be formed only in some parts (places that come into contact with the other members) of the surfaces of cushions 13a to 13d. In this case, similarly, a range of contact areas (range where films are stuck) is advisably determined based on the moving range of main pump body 1 due to thermal expansion of communicating tube 3 or vibration during transport. Limiting a film forming range enables cost reduction.

When the films are partially provided, film sticking positions on the cushion surfaces must be accurately obtained. On the other hand, when the films are arranged on the entire cushion surfaces, film sticking positions do not need to be accurately obtained, and hence the films and the cushions can be easily stuck together.

Next, a structure of attaching the pump unit according to the embodiment to a casing of an electronic device will be described.

FIG. 5 is a perspective view showing a configuration of a projector on which the pump unit according to the embodiment is mounted. Referring to FIG. 5, projector 200 includes casing 200a for housing a light source, a liquid crystal display panel, and an illumination optical system that irradiates the liquid crystal panel with light from the light source, and detachable pump unit 100 loaded on casing 200a. Pump unit 100 is the aforementioned pump unit according to the embodiment.

A portion of casing 200a to fix pump unit 100 includes member 201 for forming a main-body cooling ventilating hole, to which gasket portion 3a of communicating tube 3 is pressed, projection 202 engaged with receiving portion 4b of cover 4, and hole 203 to insert projection 4a of cover 4.

As shown in FIG. 5, member 201 for forming the main-body cooling ventilating hole includes planar receiving portion 2012 having ventilating hole 2011 formed in its center, communicating tube 2013 for connecting ventilating hole 2011 to a tube (communicating tube for guiding compressed air discharged from main pump body 1 to the heat source) in casing 200a, and protrusion 2014 formed on receiving portion 2012 to surround ventilating hole 2011. Member 201 for forming the main-body cooling ventilating hole is attached to a wall portion of the side into which projection 4a of cover 4 is inserted. Protrusion 2014 is provided to keep airtightness.

FIG. 7 shows a sectional structure in a state where pump unit 100 is loaded on casing 200a. As shown in FIG. 7, pump unit 100 is positioned with respect to casing 200a by inserting projection 4a of pump unit 100 into hole 203 of casing 200a and by engaging receiving portion 4b of pump unit 100 with projection 202 of casing 200a. In the positioned state, hole 4d is located directly above a screw hole formed in projection 202 of casing 200a. Pump unit 100 is fixed to casing 200a by inserting screw 204 through hole 4d into the screw hole of casing 200a.

In the fixed state of pump unit 100 to casing 200a, gasket portion 3a of communicating tube 3 is pressed, by the surface constituted by front wall portions 211 and 221, against receiving portion 2012 of member 201 for forming the main-body cooling ventilating hole by an appropriate force. This results in a state in which the discharge opening of the end of communicating tube 3 and ventilating hole 2011 of receiving portion 2012 are in communication with each other. Thus, high static-pressure air discharged from discharge opening 11 of main pump body 1 can be supplied from ventilating hole 2011 into the tube in casing 200a. The heat source such as a light source is located ahead of the tube, and a desired place of the heat source can be cooled by the compressed air from main pump body 1.

The force of pressing gasket portion 3a that is applied to receiving portion 2012 is uniform on the entire surface. To obtain the force of pressing gasket portion 3a applied against protrusion 2014 of receiving portion 2012, in the fixed state of pump unit 100 to casing 200a, an interval D between the surface (pressing surface) constituted by front wall portions 211 and 221 and receiving portion 2012 (ventilating hole forming surface) of member 201 for forming the main-body cooling ventilating hole is set smaller than the total of thickness T1 of gasket portion 3a and thickness T2 of protrusion 2014. Depending on a size of the interval D with respect to thickness (T1+T2), a force of pressing gasket portion 3a against receiving portion 2012 is determined. Since the ([T1+T2]−D) value is larger, the force of pressing gasket portion 3a against protrusion 2014 is greater. As a result, the effect of preventing air leakage is higher.

In the fixed state of pump unit 100 to casing 200a, the pressing surface and the ventilating hole forming the surface are placed almost parallel to each other. This enables pressing of gasket portion 3a against entire protrusion 2014 by a uniform force.

Guide portion 213 and screwing portion 223 are arranged on a rear portion of wall portions 211 and 221 (side opposed to the side where gasket portion 3a is disposed), thereby increasing rigidity of the surface constituted by wall portions 211 and 221. Thus, gasket portion 3a can be pressed against protrusion 2014 of receiving portion 2012.

Protrusion 2014 is advisably positioned oppositely to the highly rigid portion of the surface constituted by wall portions 211 and 221. Specifically, protrusion 2014 is advisably disposed in a position facing the portion where guide portion 213 and screwing portion 223 are arranged. Thus, when gasket portion 3a is pressed against protrusion 2014 by the surface constituted by wall portions 211 and 221, gasket portion 3a can be crushed by the highly rigid portion of the surface. When the surface is low in rigidity, it is difficult to press gasket portion 3a against protrusion 2014 by a uniform force, and air leakage may occur.

The pump unit described above is an example of the present invention. The configuration can be appropriately changed without departing from the gist of the present invention. For example, the buffer members (cushions) are arranged in the portions of the main pump body likely to come into contact with the other members. In place of these portions, the buffer members can be located in portions of the cover or the casing side that come into contact with the main pump body side. The buffer members can be arranged on both the main pump body side and the member side of the cover or the casing. In any case, the lubricating members (films) rare arranged on the surfaces of the buffer members. This can prevent problems such as crushing of the cushions or wear of the cushions due to thermal expansion of the communicating tube.

The pump unit employs the exchangeable unit structure. However, the pump unit can be a fixed unit integrally attached to the casing.

The pump unit of the present invention can be applied to a general computer, a general information processing apparatus represented by a personal computer, and a general display apparatus represented by a liquid crystal display apparatus or a plasma display.

1. A pump unit that includes a cooling pump which discharges compressed air and a cover which houses the cooling pump, the pump unit comprising:
a communicating tube one end of which is fitted to a discharge opening of the cooling pump and in which a portion other than the fitting portion is set as a fixing portion with the cover, the communicating tube being made of an elastomer;
buffer members which are arranged on an outer circumferential surface of the cooling pump; and
lubricating members which are arranged on surfaces of the buffer members,
wherein the lubricating members include smooth surfaces, and friction coefficients of the smooth surfaces are smaller than those of the buffer members.

2. A pump unit that includes a cooling pump which discharges compressed air and a cover which houses the cooling pump, the pump unit comprising:
a communicating tube one end of which is fitted to a discharge opening of the cooling pump and in which a portion other than the fitting portion is set as a fixing portion with the cover, the communicating tube being made of an elastomer;
lubricating members which are arranged on an inner surface of the cover; and
lubricating members which are arranged on surfaces of the buffer members,
wherein the lubricating members include smooth surfaces, and friction coefficients of the smooth surfaces are smaller than those of the buffer members.

3. A projection display apparatus that includes a light source and an optical system that projects image light obtained by spatially modulating light from the light source, the projection display apparatus comprising:
a casing which houses the light source and the optical system; and
a pump unit which is attached to the casing,
wherein:
the pump unit includes:
a cooling pump which discharges compressed air;
a communicating tube one end of which is fitted to a discharge opening of the cooling pump and in which a portion other than the fitting portion is set as a fixing portion with the cover, the communicating tube being made of an elastomer;
buffer members which are arranged on an outer circumferential surface of the cooling pump; and
lubricating members which are arranged on surfaces of the buffer members;
wherein:
the lubricating members include smooth surfaces, and friction coefficients of the smooth surfaces are smaller than those of the buffer members; and
at least the light source is cooled by the compressed air introduced into the casing through the communicating tube.

4. A projection display apparatus that includes a light source and an optical system that projects image light obtained by spatially modulating light from the light source, the projection display apparatus comprising:
a casing which houses the light source and the optical system; and
a pump unit which is attached to the casing,
wherein:
the pump unit includes:
a cooling pump which discharges compressed air;
a communicating tube one end of which is fitted to a discharge opening of the cooling pump and in which a portion other than the fitting portion is set as a fixing portion with the cover, the communicating tube being made of an elastomer;
lubricating members which are arranged on an inner surface of the cover; and
lubricating members which are arranged on surfaces of the buffer members;
wherein:
the lubricating members include smooth surfaces, and friction coefficients of the smooth surfaces are smaller than those of the buffer members; and
at least the light source is cooled by the compressed air introduced into the casing through the communicating tube.

5. The projection display apparatus according to claim 3, further comprising:
other buffer members which are arranged on the inner surface of the casing; and
other lubricating members which are disposed on surfaces of the other buffer members,
wherein the other lubricating members include smooth surfaces, and friction coefficients of the smooth surfaces are smaller than those of the other buffer members.

6. The projection display apparatus according to claim 4, further comprising:
other buffer members which are arranged on the inner surface of the casing; and
other lubricating members which are disposed on surfaces of the other buffer members,
wherein the other lubricating members include smooth surfaces, and friction coefficients of the smooth surfaces are smaller than those of the other buffer members.
